(19) United States
(12) Patent Application Publication
(10) Pub. No.: US 2022/0110318 A1
(43) Pub. Date: Apr. 14, 2022

(54) COMPOSITIONS AND METHODS FOR POLLEN STORAGE AND PRESERVATION

(71) Applicant: PIONEER HI-BRED INTERNATIONAL, INC., JOHNSTON, IA (US)

(72) Inventors: MAREN L ARLING, DES MOINES, IA (US); EMILY BERNTSON, ANKENY, IA (US); KEVIN DAY, BOONE, IA (US); WILLIAM JAMES GORDON-KAMM, URBANDALE, IA (US); HENA GUO, JOHNSTON, IA (US); JUSTIN ANDREW SCHARES, AMES, IA (US); YUE YUN, JOHNSTON, IA (US)

(73) Assignee: PIONEER HI-BRED INTERNATIONAL, INC., JOHNSTON, IA (US)

(21) Appl. No.: 17/275,536

(22) PCT Filed: Sep. 5, 2019
(86) PCT No.: PCT/US19/49625

§ 371 Date: Mar. 11, 2021

Related U.S. Application Data
(60) Provisional application No. 62/731,284, filed on Sep. 14, 2018.

(51) Int. Cl. A01N 3/00; A01H 1/02; A01N 33/12

(52) U.S. Cl. CPC A01N 3/00; A01N 33/12; A01H 1/02

(57) ABSTRACT

Liquid compositions for preserving and storing pollen, especially maize pollen, include pollen suspensions in solutions with particular pH ranges. Methods for preserving and storing pollen, especially maize pollen, include suspending pollen in solutions with particular pH ranges and storing them at particular temperatures.

### BACKGROUND

Extending the viability of pollen, and especially pollen from maize, would provide significant value to seed production and plant breeding. Pollen viability can be lost quickly after being shed, and its longevity is influenced by many species-specific and environmental factors, including temperature and humidity. The ability to preserve pollen viability would allow plant breeders and seed producers to grow plants designated as males (pollen producers) in different spaces or times than those designated as females (pollen acceptors).

Field cost is a significant part of the production costs for seed production. Decreasing acres, variability and error during seed production are some of the opportunities to decrease costs. In maize seed production, to ensure sufficient pollen shedding from male plants to pollenate all female ears, excess male rows are usually planted. Improved pollen preservation would provide benefits by allowing creation of pollen stockpiles that could be used at different times and across different genetic backgrounds that would normally not mature at compatible rates. Sufficient pollen applied from preserved pollen can help free up the current necessity to dedicate field space to male plants completely or reduce the additional planting of male rows, allowing more efficient use of available field resources. In addition, variation from field to field is one of the challenges for predicting seed production supply needs for each seed production cycle. Supplemental preserved viable pollen can be applied within a standard conservative female:male row planting ratio to ensure the complete pollination and realization of genetic female yield potential.

Loose pollen viability varies among different species and genetic backgrounds and may be influenced by surrounding temperature, moisture and other environmental conditions. Prior efforts to preserve maize pollen have focused on reducing the water content of the pollen by drying to below 30% and cryo-preserving the pollen in dry ice or liquid nitrogen. However, cryo-preservation has many practical challenges. Furthermore, dry pollen is unstable at room temperatures, and cryo-preservation requires expensive equipment. Also, dry pollen can be difficult to disperse in a seed production field.

Therefore, there is a need in the agricultural arts, and in particular for seed production and plant breeding, for improved pollen preservation systems and methods that allow viability preservation at warmer temperatures and allow for more robust dispersal methods.

### SUMMARY

In one embodiment, the method involves making a liquid composition comprising greater than 50% water, viable maize pollen, at least one plant nutrient, and greater than 0.5 molarity of an osmotic potential enhancing compound; and wherein the liquid composition has a pH greater than 8. In another embodiment, the pH of the liquid composition is greater than 9.

The liquid composition may further comprise a plant micronutrient and/or macronutrient. The micronutrient may comprise boron. The macronutrient may comprise calcium.

The osmotic potential enhancing compound may comprise betaine, and optionally, sucrose. The liquid composition of betaine in the osmotic potential enhancing compound may be equal or greater than 500 mM. In some embodiments, the liquid composition of betaine in the osmotic potential enhancing compound is equal or greater than 1000 mM.

The osmotic potential enhancing compound may comprise phosphate-buffered saline (PBS) at a concentration equal or greater than 0.25×, based on a 20× PBS stock adjusted to a pH of 9.

In one embodiment, the liquid composition may comprise boric acid, calcium chloride, and at least 500 mM betaine. In another embodiment, the liquid composition may comprise boric acid, calcium chloride, and at least 1000 mM betaine.

In another embodiment, the method involves storing maize pollen in an aqueous solution comprising collecting maize pollen and storing the collected maize pollen in an aqueous solution, the aqueous solution comprising greater than 50% water and greater than 0.5 molarity of an osmotic potential enhancing compound, wherein the liquid composition has a pH greater than 8. In another embodiment the pH is greater than 9. The pollen may be collected from a shedding maize anther and then placed in the aqueous solution. The aqueous solution may comprise calcium chloride, boric acid, and betaine. In another embodiment, the aqueous solution may comprise phosphate buffered saline.

In another embodiment, at least one pollen encapsulating agent is added to the aqueous solution. The pollen encapsulating agent may be oil and/or honey phenolic acids with flavonoids.

In other embodiment, the method comprises collecting maize pollen and storing the collected maize pollen in an aqueous solution, the aqueous solution comprising greater than 50% water and greater than 0.5 molarity of an osmotic potential enhancing compound, and applying the solution to the silk of the same or a different maize plant. In one embodiment, the aqueous solution may be sprayed onto the silk of the same or a different maize plant.

### DESCRIPTION

This invention enables pollen storage using liquid media with additives, providing benefits not available to prior dry loose pollen preservation approaches that control only temperature and/or humidity. While cold storage is beneficial to both dry and liquid storage, we have found that liquid can provide greater stability at room temperature than dry storage, and liquid storage enables easier handling in a field environment and more flexibility for collection and storage. In addition, we have also found that liquid media has increased compatibility with sprayers, potentially simplifying the method of dispersing stored pollen onto a field for pollination. Surfactants may be added to the liquid media comprising the pollen to improve interaction between the liquid media and the silks. Sprayers refers to any device that disperses a stream or droplets of the liquid media comprising the pollen. As used herein, liquid refers to a material in a fluid state, as distinguished from a solid, gas or plasma state, that conforms to the shape of its container but retains a nearly constant volume independent of pressure. As used herein, aqueous refers to a solution or composition in which the solvent is water, and is in a liquid state.

The invention includes aqueous formulations that preserve pollen suspended in solution. The pH of the solution is preferably basic, with the pH being greater than or equal to 7, preferably greater than or equal to 8, and most preferably great than or equal to 9. The formulations may include additives for increasing osmotic potential to balance and protect pollen grains from rupture and maintain pollen viability. Examples of osmotic potential enhancing compounds include betaine (in any form, such as those listed below), phosphate-buffered saline (PBS), tris-buffered saline (TBS), and poly-ethylene glycol (PEG). Other osmotic potential enhancing compounds include mono-, di-, oligo- and polysaccharides, such as glucose, fructose, sucrose, trehalose, raffinose and fructans; sugar alcohols (polyols) such as sorbitol, mannitol, glycerol, inositol and methylated inositols; amino acids, such as proline, pipecolic acid; methylated proline-related compounds, such as methyl-proline, proline betaine and hydroxyproline betaine; other betaines, such as glycine betaine, β-alanine betaine, choline O-sulphate; and tertiary sulphonium compounds, such as dimethylsulphoniopropionate (DMSP).

In some embodiments, pollen may be preserved by encapsulation in high-density environments including hone, phenolic acids and flavonoids, mineral oil, olive oil, silicone oil, or other compatible and stabile oils. In some embodiments, surfactants may be added to the liquid media comprising the pollen to improve the interaction between the liquid media and the silks, to prevent the liquid media from beading up on the silks, which limits potential contact between the pollen in the liquid media and the silk tissue.

### EXAMPLES

### Example 1: Storage of Maize Pollen in Liquid Media Environment—pH Effects

This example assesses the impact of pH on stabilizing maize pollen in liquid environments.

Solutions adjusted to pH 7.0, 8.0, and 9.0 using HCl and KOH were made from aliquots of sterile distilled water. Pollen was collected from actively shedding maize tassels and added to each solution. Pollen was stored at room temperature (21° C.) for up to 7 days and observed periodically using an inverted microscope.

Increasing pH to 9.0 showed increased pollen stability and lowered cell lysis compared to pH 7.0 or pH 8.0, which showed widespread lysis of the pollen grains (Table 1).

TABLE 1
Comparison of pollen grains stored in water adjusted
to pH of 7.0, 8.0, and 9.0 after 7 days

| Adjusted Water pH | Intact pollen grains |
|---|---|
| pH 7.0 | Widespread lysis |
| pH 8.0 | Widespread lysis |
| pH 9.0 | ~90-95% intact |

Higher pH therefore has a stabilizing effect on maize pollen and prevented lysis in a liquid environment.

### Example 2: Storage of Maize Pollen in Liquid Media Environment—Effects of Media Components and Plant Nutrients

This example assesses the effects of components of liquid media on pollen stability. Three aqueous media bases were prepared: sterile distilled water, 0.6 M mannitol, and 326C media. The pH was adjusted to 9.0 for all three media. Media recipes are set forth below.

Pollen was collected from actively shedding maize tassels and added to each of the media solutions described above. Pollen was stored at room temperature (21° C.) for up to 7 days and observed periodically using an inverted microscope.

Sterile water showed some cell lysis, and 0.6 M mannitol showed more wide-spread cell lysis. 326C media showed greater stability and less lysis compared to the other two medias (Table 2).

TABLE 2
Intact pollen grain comparison of pollen stored in water,
0.6M mannitol, and 326C media adjusted to pH 9.0

| Media | Intact pollen grains |
|---|---|
| Water | ~80-85% intact |
| 0.6M Mannitol | Widespread lysis |
| 326C | >95% intact |

Next, the effects of micronutrients such as Boron and Macronutrients such as Calcium in the 326C media were determined by preparing 326C without Boron and Calcium (326C-S). Aliquots of both the complete 326C and 326C-S were prepared and adjusted to pH of 6.0, 7.0, 8.0, and 9.0. Pollen was collected as above and stored at room temperature. Micronutrients are nutrients needed in small amounts for normal or optimum plant growth, which include iron (Fe), boron (B), chlorine (Cl), manganese (Mn), zinc (Zn), copper (Cu), molybdenum (Mo), nickel (Ni). Macronutrients are needed in larger amounts than micronutrients, and include nitrogen (N), phosphorus (P), potassium (K), calcium (Ca), sulfur (S), magnesium (Mg), carbon (C), oxygen (O), and hydrogen (H).

When comparing the complete 326C media against the 326C-S media, widespread cell lysis with the 326C-S media was observed, while the pollen stored in complete 326C remained intact (Table 3).

TABLE 3
Intact pollen grain comparison of pollen stored
in 326C media and 326C-S (salts removed) media
adjusted to pH of 6.0, 7.0, pH 8.0, and pH 9.0

| Media | Intact pollen grains |
|---|---|
| 326C, pH 6.0 | Widespread lysis |
| 326C, pH 7.0 | ~30-35% intact |
| 326C, pH 8.0 | ~80-85% intact |
| 326C, pH 9.0 | ~90-95% intact |
| 326C-S, pH 6.0 | Widespread lysis |
| 326C-S, pH 7.0 | Widespread lysis |
| 326C-S, pH 8.0 | Widespread lysis |
| 326C-S, pH 9.0 | Widespread lysis |

Osmotic potential by itself is insufficient to maintain pollen stability. The presence of salts (e.g., Calcium and Boron) is important for maintaining the stability of the pollen.

### Example 3: Storage of Maize Pollen in Liquid Media Environment—Effects of Media Additives

This example assesses additives to liquid media on pollen viability.

The 326C media described in the previous example was prepared with four concentrations of the osmoprotectant compound Betaine: no Betaine, 100 mM Betaine, 500 mM Betaine, and 1000 mM Betaine. Aliquots of each was prepared and adjusted to pH 6.0, 7.0, 8.0, and 9.0 for a total of sixteen solutions (four Betaine concentrations, each at four different pHs).

Pollen was collected from actively shedding maize tassels and added to each of the twelve media. Pollen was stored at 4° C. and observed microscopically. Viability was assayed using Fluorescein Diacetate (FDA) viability staining. Viability observations were taken at 8 and 15 days after being placed in storage.

Increased FDA fluorescence was shown as both pH and Betaine concentration increase, with highest viability fluorescence present at pH 9.0 and 1000 mM Betaine. These parameters also showed high viability at both 8 and 15 days of storage (Table 4 and Table 5).

TABLE 4
Percentage of pollen grains showing fluorescence from FDA staining
after storage in liquid media for eight days at 4 C.

| Media | FDA Fluorescence |
|---|---|
| 326C, pH 6.0, No Betaine | 0% |
| 326C, pH 6.0, 100 mM Betaine | 5-10% |
| 326C, pH 6.0, 500 mM Betaine | 15-20% |
| 326C, pH 6.0, 1000 mM Betaine | 30-35% |
| 326C, pH 7.0, No Betaine | >5% |
| 326C, pH 7.0, 100 mM Betaine | 5-10% |
| 326C, pH 7.0, 500 mM Betaine | 45-50% |
| 326C, pH 7.0, 1000 mM Betaine | 60-65% |
| 326C, pH 8.0, No Betaine | 25-30% |
| 326C, pH 8.0, 100 mM Betaine | 45-50% |
| 326C, pH 8.0, 500 mM Betaine | 80-85% |
| 326C, pH 8.0, 1000 mM Betaine | 90-95% |
| 326C, pH 9.0, No Betaine | 20-25% |
| 326C, pH 9.0, 100 mM Betaine | 5-10% |
| 326C, pH 9.0, 500 mM Betaine | 85-90% |
| 326C, pH 9.0, 1000 mM Betaine | 90-95% |

TABLE 5
Percentage of pollen grains showing fluorescence from FDA staining
after storage in liquid media for fifteen days at 4 C.

| Media | FDA Fluorescence |
|---|---|
| 326C, pH 6.0, No Betaine | 0% |
| 326C, pH 6.0, 100 mM Betaine | 0% |
| 326C, pH 6.0, 500 mM Betaine | 0% |
| 326C, pH 6.0, 1000 mM Betaine | >5% |
| 326C, pH 7.0, No Betaine | 0% |
| 326C, pH 7.0, 100 mM Betaine | 0% |
| 326C, pH 7.0, 500 mM Betaine | >5% |
| 326C, pH 7.0, 1000 mM Betaine | 5-10% |
| 326C, pH 8.0, No Betaine | >5% |
| 326C, pH 8.0, 100 mM Betaine | 40-45% |
| 326C, pH 8.0, 500 mM Betaine | 35-40% |
| 326C, pH 8.0, 1000 mM Betaine | 80-85% |
| 326C, pH 9.0, No Betaine | 5-10% |
| 326C, pH 9.0, 100 mM Betaine | 10-15% |
| 326C, pH 9.0, 500 mM Betaine | 30-35% |
| 326C, pH 9.0, 1000 mM Betaine | 85-90% |

This example demonstrates that additives to increase osmotic potential, such as Betaine, increase pollen viability over longer durations of time.

### Example 4: PBS

The purpose of this experiment is to test additional additives for liquid storage media. For this test, phosphate-buffered saline (PBS) is added. Two stocks of 326C media were prepared, one with Betaine at a 1000 mM concentration, the other without Betaine. 20× PBS stock was added to create final PBS concentrations of 0.00×, 0.10×, 0.25×, 0.50×, 0.75×, 1.00×, 1.50×, and 2.00×. Solution pH was adjusted to 9.0.

Pollen was collected from actively shedding maize tassels and added to each media. Pollen was stored at 4 C and observed using the Lionheart FX Live Image Capture. Viability was assayed using FDA viability staining. Viability observations were taken at 4 days after being placed in storage.

TABLE 6
Phosphate Buffered Saline (PBS)

| Media | FDA Fluorescence |
|---|---|
| 326C, 1M Betaine, 0.00x PBS | 10-15% |
| 326C, 1M Betaine, 0.10x PBS | 10-15% |
| 326C, 1M Betaine, 0.25x PBS | 10-15% |
| 326C, 1M Betaine, 0.50x PBS | 5-10% |
| 326C, 1M Betaine, 0.75x PBS | 15-20% |
| 326C, 1M Betaine, 1.00x PBS | 10-15% |
| 326C, 1M Betaine, 1.50x PBS | 5-10% |
| 326C, 1M Betaine, 2.00x PBS | 5-10% |
| 326C, 0.00x PBS | 0% |
| 326C, 0.10x PBS | 0% |
| 326C, 0.25x PBS | >5% |
| 326C, 0.50x PBS | 0% |
| 326C, 0.75x PBS | >5% |
| 326C, 1.00x PBS | 0% |
| 326C, 1.50x PBS | >5% |
| 326C, 2.00x PBS | >5% |

Without Betaine, 326C with PBS showed low FDA fluorescence, though there were some fluorescent pollen above 0.25× concentration. With Betaine, we see an increase in FDA fluorescence at 0.75× concentration, and a decrease at 1.50× and above. Therefore, when used in combination with Betaine, PBS improved pollen viability.

### Example 5: Germination of Maize Pollen after Storage in a Liquid Media Environment

This example confirms the ability of pollen to germinate after it has been stored in a liquid environment.

Maize pollen was stored in 326C media with 1000 mM Betaine at a pH of 9.0. Pollen was stored at 4° C. for six days. After six days, the storage media was carefully removed from the pollen and replaced with a modified germination media at room temperature to trigger pollen tube formation. Pollen was observed microscopically prior to replacement of media and two hours after replacement.

Within two hours, pollen tube formation was readily observable in samples where the storage media had been removed and replaced with germination media. Samples that did not undergo the media replacement did not show pollen tube formation. Pollen was viable stored using the developed storage media and is capable of pollen germination after removal from storage.

### Example 6: Use of Protective Compounds in Pollen Preservation

In this example, various putative protective compounds were evaluated for their efficacy in preventing pollen from bursting on germination media. Nine different chemical treatments were applied to loose pollen shed from maize plants. Pollen was soaked in chemical solution for 20 minutes and then placed on media to observe the impact on pollen viability and compared with fresh pollen without protection as control.

A liquid composition comprising 1XPBS at PH7.4, honey, olive oil, and mineral oil was cound to prevent pollen from bursting. A liquid composition comprising 50% glycols, 5% DMSO and hair spray application did not prevent pollen from bursting on media in significantly less quantities than control (germination media alone).

### Example 7: Pollen Germination Assay—Effect of Sugars on Pollen Viability and Fertility

In this example, various concentrations of sucrose mannitol were added to the germination medium in order to evaluate any effects they have on pollen germination.

Four different sugar compositions (16% sucrose, 12% sucrose and 4% mannitol, 16% sucrose and 4% mannitol, and 20% sucrose and 4% mannitol) were added to germination medium, and the effects of the compositions on pollen collected from two genetically different maize plants were observed microscopically and the percentage of pollen grains that germinated and that ruptured were quantified. Some pollen grains ruptured after germinating first, which is why Table 7 below shows some rupture and germination percentages that exceeded 100%. The sugar compositions above were added to a germination medium comprising Agar 0.7%, CaCl2 2H2O 300 mg/L, and H3BO3 100 mg/L. Table 7 below reports the results.

TABLE 7
Effects of sugar compositions in
germination media on germination.

| Sugar | Maize Plant 1 Results | | Maize Plant 2 Results | |
|---|---|---|---|---|
| Composition | Germination | Rupture | Germination | Rupture |
| 16% Sucrose | 90% | 30% | 90% | 25% |
| 12% Sucrose | 45% | 45% | 60% | 50% |
| 4% Mannitol | | | | |
| 16% Sucrose | 10% | 25% | 10% | 30% |
| 4% Mannitol | | | | |
| 20% Sucrose | 5% | 10% | 2% | 20% |
| 4% Mannitol | | | | |

These results show a very high rate of germination success using a germination medium including 16% sucrose and no mannitol.

### Media Recipes

0.6 M Mannitol (1 L)
Mannitol—109.32g
L-Proline—0.146 g
Adjust pH to 7.0, 8.0, and 9.0
326C Media (1 L)
Sucrose—160.0 g
Calcium Chloride Dihydrate—0.3 g
Boric Acid—0.1 g
Adjust pH to 6.0, 7.0, 8.0, and 9.0
326C-S Media (1 L)
Sucrose—160.0 g
Adjust pH to 6.0, 7.0, 8.0, and 9.0
326C, 100 mM Betaine (1 L)
Sucrose—160.0 g
Calcium Chloride Dihydrate—0.3 g
Boric Acid—0.1 g
5 M Betaine—20 mL
Adjust pH to 6.0, 7.0, 8.0, and 9.0
326C, 500 mM Betaine (1 L)
Sucrose—160.0 g
Calcium Chloride Dihydrate—0.3 g
Boric Acid—0.1 g
5 M Betaine—100 mL
Adjust pH to 6.0, 7.0, 8.0, and 9.0
326C, 1000 mM Betaine (1 L)
Sucrose—160.0 g
Calcium Chloride Dihydrate—0.3 g
Boric Acid—0.1 g
5 M Betaine—200 mL
Adjust pH to 6.0, 7.0, 8.0, and 9.0
20× PBS
NaCL—160 g
KCL—4 g
NA2HPO4—28.8 g
KH2PO4—4.8 g
H2O—800 ml

### Example 8: Addition of Surfactants—Germination of Maize Pollen After Storage in a Liquid Media Environment Comprising Surfactants

This example examines the use of surfactants in media to improve contact between pollen-containing liquid media and silk tissue.

Maize pollen was stored in 326C media with 1000 mM Sucrose and 500 mM Betaine at a pH of 9.0. Pollen was stored at 1° C. for a day. After this time period, germination medias comprising surfactant were added in amounts up to five times the volume of storage media. Surfactant conditions tested were 0.1% Tween 20, 0.01% Tween 20, 0.1% Pluronic F68, and 0.01% Pluronic F68 (final concentration). Pollen was observed microscopically prior to replacement of media and two hours after replacement. Pluronic F68, also known as poloxamer 188, is a non-ionic surfactant, a member of a class of polaxamers comprising non-ionic triblock copolymers composed of a central hydrophobic chain of polyoxypropylene flanked by two hydrophilic chains of polyoxyethylene.

Within two hours, pollen tube formation was observable. Pollen treated with germination media containing Pluronic F68 at both 0.01% and 0.1% concentrations showed pollen tube formation similar to germination media without surfactant. Pollen treated with germination media containing Tween 20 showed lysis but no pollen tube formation at both concentrations. Under these conditions, pollen shows sensitivity to surfactants, but Pluronic F68 was gentle enough that it did not interfere with pollen tube formation.

### Example 9: Techniques used for Enhanced Fertilization of Female Maize Gamete from Pollen Stored in Liquid Media Environment Containing Surfactants

These examples outline the techniques used to improve the effectiveness of pollen application onto silk tissue from a liquid media environment for successful fertilization.

Filter and spatula: Maize pollen was stored in 326C media with 1000 mM Sucrose, 500 mM Betaine, and 0.1% Pluronic F68 (poloxamer 188) for a series of time points. The treatments were stored in a cooler with 1 C cooler packs or in a 1 C fridge. Once ready, the contents of the culture plate well was removed and placed into a 40 um filter. A kimwipe was used to wick away excess storage media. A spatula was then used to scoop up the pollen and apply it onto the silks.

Spray Bottle Head: Maize pollen was stored in 326C media with 1000 mM Sucrose, 500 mM Betaine, and 0.1% Pluronic F68 for a series of time points. The treatments were stored in a cooler with 1C cooler packs or in a 1C fridge. Once ready, the contents of the solution was drawn up through the inlet of the spray bottle head and dispersed onto the silks. Alternatives of this was to substitute the storage media for mineral oil or to add mineral oil to the storage media, mix to encapsulate the pollen, and spray onto the silks.

Brush: Maize pollen was stored in 326C media with 1000 mM Sucrose, 500 mM Betaine, and 0.1% Pluronic F68 for a series of time points. The treatments were stored in a cooler with 1C cooler packs or in a 1C fridge. Once ready, the contents of the solution was removed from the well but the pollen was maintained, light mineral oil was added, and then applied to silks using a brush or pipette. Alternatively, the contents of the well were removed, added to a filter, and then light mineral oil was added to the filter. The liquid in the filter was then used for applying pollen to the silks with a small paint brush.

Negative Control: Maize pollen was stored in water for 30 min. A filter and spatula was used to apply the pollen onto the silks.

In summary, kernel formation/seed set was obtained from pollen that was stored in the liquid media environment up to four hours. Our negative control using water as the liquid media environment showed no kernel formation/seed set after being stored for 30 minutes.

TABLE 8
Kernel count results of pollen in storage media using different
pollen application techniques from a liquid media environment

| | | | Kernel Count | Kernel Count | Liquid Stored |
|---|---|---|---|---|---|
| Experiment | Location | Treatment | (Fresh - Dry) | (Liquid Stored) | Time (min) |
| 1 | GH | Filter and spatula | 480 | 72 | 30 |
| 2 | GH | Filter and spatula | 444 | 85 | 30 |
| 3 | GH | Filter and spatula | 454 | 116 | 30 |
| 4 | GH | Filter and spatula | 457 | 79 | 30 |
| 5 | GH | Filter and spatula | 549 | 78 | 30 |
| 6 | Lab | Spray bottle | 77 | 36 | 60 |
| 7 | GH | Pipette | 487 | 14 | 30 |
| 8 | GH | Brush | 549 | 23 | 30 |
| 9 | GH | Filter and spatula | — | 0 | 30 |
| | | Water | | | |
| | | (Negative Control) | | | |

We claim:

1. A liquid composition comprising:
a. greater than 50% water,
b. viable maize pollen,
c. at least one plant nutrient, and
d. greater than 0.5 molarity of an osmotic potential enhancing compound;
wherein the liquid composition has a pH greater than 8.

2. The liquid composition of claim 1, wherein the at least one plant nutrient comprises at least one micronutrient.

3. The liquid composition of claim 2, wherein the at least one micronutrient is boron.

4. The liquid composition of claim 1, wherein the plant nutrient comprises at least one macronutrient.

5. The liquid composition of claim 4, wherein the at least one macronutrient comprises calcium.

6. The liquid composition of claim 1, wherein the osmotic potential enhancing compound comprises betaine, and optionally, sucrose.

7. The liquid composition of claim 6, wherein the concentration of the betaine in the osmotic potential enhancing compound is equal or greater than 500 mM.

8. The liquid composition of claim 6, wherein the concentration of the betaine in the osmotic potential enhancing compound is equal or greater than 1000 mM.

9. The liquid composition of claim 1, wherein the osmotic potential enhancing compound comprises phosphate-buffered saline (PBS) at a concentration equal or greater than 0.25×, based on a 20× PBS stock adjusted to a PH of 9.

10. The liquid composition of claim 1, comprising boric acid, calcium chloride, and at least 500 mM betaine.

11. The liquid composition of claim 1, comprising boric acid, calcium chloride, and at least 1000 mM betaine.

12. The liquid composition of claim 1, wherein the liquid composition has a pH greater than or equal to 9.

13. The liquid composition of claim 12, wherein the at least one plant nutrient comprises at least one micronutrient.

14. The liquid composition of claim 13, wherein the at least one micronutrient is boron.

15. The liquid composition of claim 12, wherein the plant nutrient comprises at least one macronutrient.

16. The liquid composition of claim 15, wherein the at least one macronutrient comprises calcium.

17. The liquid composition of claim 12, wherein the osmotic potential enhancing compound comprises betaine, and optionally, sucrose.

18. The liquid composition of claim 17, wherein the concentration of the betaine in the osmotic potential enhancing compound is equal or greater than 500 mM.

19. The liquid composition of claim 17, wherein the concentration of the betaine in the osmotic potential enhancing compound is equal or greater than 1000 mM.

20. The liquid composition of claim 12, wherein the osmotic potential enhancing compound comprises phosphate-buffered saline (PBS) at a concentration equal or greater than 0.25×, based on a 20× PBS stock adjusted to a PH of 9.

21. The liquid composition of claim 12, comprising boric acid, calcium chloride, and at least 500 mM betaine.

22. The liquid composition of claim 12, comprising boric acid, calcium chloride, and at least 1000 mM betaine.

23. A method of storing maize pollen in an aqueous solution comprising collecting maize pollen and storing the collected maize pollen in an aqueous solution, the aqueous solution comprising greater than 50% water and greater than 0.5 molarity of an osmotic potential enhancing compound, wherein the liquid composition has a pH greater than 8.

24. The method of claim 23, wherein the pollen is collected from a shedding maize anther and then placed in the aqueous solution.

25. The method of claim 23, wherein the aqueous solution further comprises calcium chloride, boric acid, and betaine.

26. The method of claim 25, wherein the aqueous solution further comprises phosphate buffered saline.

27. The method of claim 23, wherein at least one pollen encapsulating agent is added to the aqueous solution.

28. The method of claim 27, wherein the pollen encapsulating agent is oil.

29. The method of claim 27, wherein the pollen encapsulating agent is honey phenolic acids with flavonoids.

30. A method of pollinating a maize plant, comprising collecting maize pollen and storing the collected maize pollen in an aqueous solution, the aqueous solution comprising greater than 50% water and greater than 0.5 molarity of an osmotic potential enhancing compound, and applying the solution to the silk of the same or a different maize plant.

31. The method of claim 30, wherein the aqueous solution is sprayed onto the silk of the same or a different maize plant.

32. The method of claim 30, wherein the aqueous solution further comprises a surfactant.

33. The method of claim 32, wherein the surfactant is a poloxamer.
